(19) United States
(12) Patent Application Publication
(10) Pub. No.: US 2008/0195748 A1
(43) Pub. Date: Aug. 14, 2008

(54) Data delivery

(75) Inventors: Lon S. Tierney, Edmonds, WA (US); Doug B. Arnett, Seattle, WA (US)

Correspondence Address: FSP LLC, P.O. BOX 890, VANCOUVER, WA, 98666, US

(73) Assignee: Melodeo Inc., Seattle, WA (US)

(21) Appl. No.: 12/005,985

(22) Filed: Dec. 28, 2007

Related U.S. Application Data
(60) Provisional application No. 60/889,028, filed on Feb. 9, 2007.

(51) Int. Cl. G06F 15/16

(52) U.S. Cl. 709/232

(57) ABSTRACT

A media server to stream content a client device over one or more network connections of varying quality includes logic to continually determine a network quality level during streaming of content, and logic to change a codec used to encode the content, the codec selected at least in part according to the network quality level.

### PRIORITY CLAIM

The present application claims priority to U.S. provisional patent application titled IMPROVED DATA DELIVERY, having application No. 60/889,028, filed on Friday, Feb. 09, 2007, which is incorporated herein by reference.

### TECHNICAL FIELD

The present disclosure relates to manners of data delivery over data networks.

### BACKGROUND

Today, many content delivery systems package a media file in one manner i.e. encode it with one codec, save it, and then stream the content when the receiving device can support that codec. The matching of content/codec and available bandwidth may be performed in a straightforward, non-dynamic manner which does not result in most efficient and best usage of available network and client capabilities. Thus too much data may be forced through a momentarily congested network, resulting in unnecessary retries (causing more congestion), lost data, and poor reception. Or, the content delivery system may “play it safe” and not make full use of available resources, resulting in underflow. Streaming to a client device may be achieved with a lesser quality (and thus for the user, a possibly degraded experience) over what is possible with a more adaptive approach.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of content selection logic.

FIG. 2 is a block diagram of an embodiment of logic to compute client average bandwidth.

FIG. 3 is an illustration of an embodiment of a content delivery system.

FIG. 4 is a flow chart of an embodiment of a content selection process.

FIG. 5 is a block diagram of an embodiment of data packet size determination logic.

FIG. 6 is a block diagram of an embodiment of factors of handset and client capabilities.

FIG. 7 is a block diagram of an embodiment of factors of network quality.

FIG. 8 is a flow chart of an embodiment of a data packet size determination process.

FIG. 9 is a sequence diagram of one embodiment of client-server interaction for dynamic content selection.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

The present disclosure describes improved data delivery mechanisms over unpredictable data paths. The described techniques may be particularly suitable for delivering audio and/or video data streams over networks that include, at least in part, a wireless connection between the media server and the client device.

Two general techniques are described. The first involves dynamically selecting the content to stream as network quality varies over time. Changing the content selection may involve selecting a new source file having a different encoding than the one currently being streamed. The content selection may also be changed by introducing or changing a codec that is used to reencode the content as it is streamed. In either case the streaming event continues and the user experiences the same program as before, but with different quality to reflect changing network quality conditions.

The second technique for adaptive data delivery involves actively altering the size of the data packets that make up the content stream. Dynamically altering the packet size according to network quality may act to reduce underflow conditions at the client device that result in gaps in the presentation of the content.

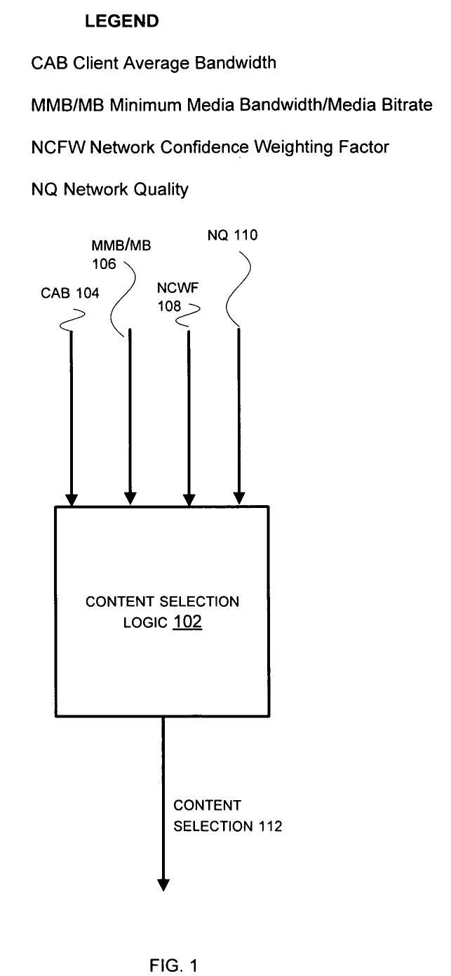

FIG. 1 is a block diagram of an embodiment of content selection logic. Content selection may occur prior to, upon initiation of, and/or during data streaming.

Content selection may include consideration of Client Average Bandwidth (CAB) 104, Minimum Media Bandwidth (MMB) and Media Bitrate (MB) 106, a Network Confidence Rating Factor (NCFW) 108, and Network Quality estimation (NQ) 110.

A running calculation is stored that represents the Client's Average Bandwidth 104 for one or more streaming events. During streaming, this value may be employed to lookup, estimate, and/or predict a Network Quality 110 level. Initial content selection (prior to or at stream initiation) may employ a pre-determined value for CAB 104 depending on, among other things, the nature of the client device and the type of network by which it communicates. For example, if the network were known to comprise a certain type of wireless connection, the CAB 104 might initially be set to 90% of the total available bandwidth on this connection, as in some embodiments it may be expected that only around 90% of total bandwidth would actually be achievable for streaming over such a connection. In other cases, the initial CAB 104 may be set to zero or to the maximum available bandwidth on the network connection type.

The bitrate of the content may be determined ahead of time (prior to streaming) and may determine the Minimum Media Bandwidth 106 (MMB) required to stream the content. The Minimum Media Bandwidth 106 is the bandwidth that is minimally required to stream the content to the client without underflow. “Underflow” means that the client experiences “gaps” in the presentation of the content.

For content encoded with constant bitrate codecs, for example AMR and QCELP, the MMB 106 may remain unchanged throughout the streaming of the content. Other codecs may employ a variable (e.g. progressive) encoding scheme that enables the bitrate to change during streaming. For progressive codecs ‘average’ bitrates from encoded content files or prior streaming events may be employed to provide an estimate of the MMB 106.

$$MMB 106 = \frac{file size}{file duration} * WF$$

In this calculation, the file size may be a total size of files encoded with the variable rate codec. Likewise, the file duration may be a cumulative streaming duration of the files.

$$weighting factor ( WF ) = \frac{1}{NCWF 108}$$

The weighting factor may be derived from a Network Confidence Weighting Factor (NCWF 108). The NCWF 108 may be employed to scale the MMB 106 upwards or downwards to compensate for variable network performance.

MMB 106 requirements may be associated with Network Quality 110 (NQ) levels. This allows the content selection logic 102 to more flexibly deal with situations where the NQ 110 varies. Thus, the NQ 110 may be determined from the MMB 106 in some situations.

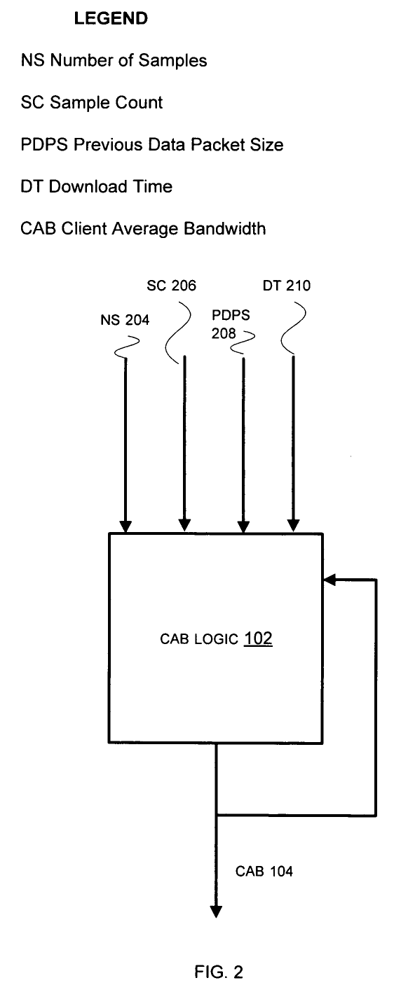

FIG. 2 is a block diagram of an embodiment of logic to compute client average bandwidth (CAB). CAB 104 may be updated periodically and may take into account multiple streaming events for a client. In some situations, the system may recognize that CAB 104 should be reset to an initial value (for example, if the client switches to another network).

The CAB 104 calculation may, in some embodiments, take into account the following factors:
Number of Samples (NS 204)

The NS 204 is a moving window of bandwidth samples. The lower the NS 204, the more volatile the CAB 104. The larger the NS 204, the slower the CAB 104 will change.
Sample Count (SC 206)

The SC 206 is the total number of samples that have gone in to the current CAB 104 calculation. SC 206 differs from NS 204 in that the SC 206 represents only the number of samples in the current CAB window.
Previous Data Packet Size (PDPS 208)

The PDPS 208 is the size of the previous data packet delivered to the client.
Download Time (DT 210)

The DT 210 is the time the client actually took to download the previous data packet.
Client Average Bandwidth (CAB 104)

A next CAB 104 value is based upon the previously calculated CAB 104 value.

Example CAB 104 Calculation

$$current bandwidth ( CB ) = \frac{PDPS 208}{DT 210}$$

The CB represents a bandwidth sample in the calculation window (NS 204) and the total number of samples (SC 206) used in the CAB 104 calculation.

SC 206=MIN(SC 206+1, NS 204)

The sample count SC 206 used in the CAB 104 calculation is effectively limited to the calculation window size MS 204. After SC 206 reaches the window size NS 204, it is limited to NS 204.

$$partial average ( PA ) = CAB 104 - \frac{CAB 104}{SC 206 + 1}$$

The partial average PA is the current CAB 104 adjusted (decreased) by an average bandwidth sample for the calculation window NS 204.

$$CAB 104 = PA + \frac{CB}{SC 206}$$

The new CAB 104 is the partial average PA adjusted (increased) by the average contribution of the current bandwidth sample. Thus, the new CAB 104 is the previous CAB adjusted by the difference of the current bandwidth sample and an average bandwidth sample for the calculation window NS 204.

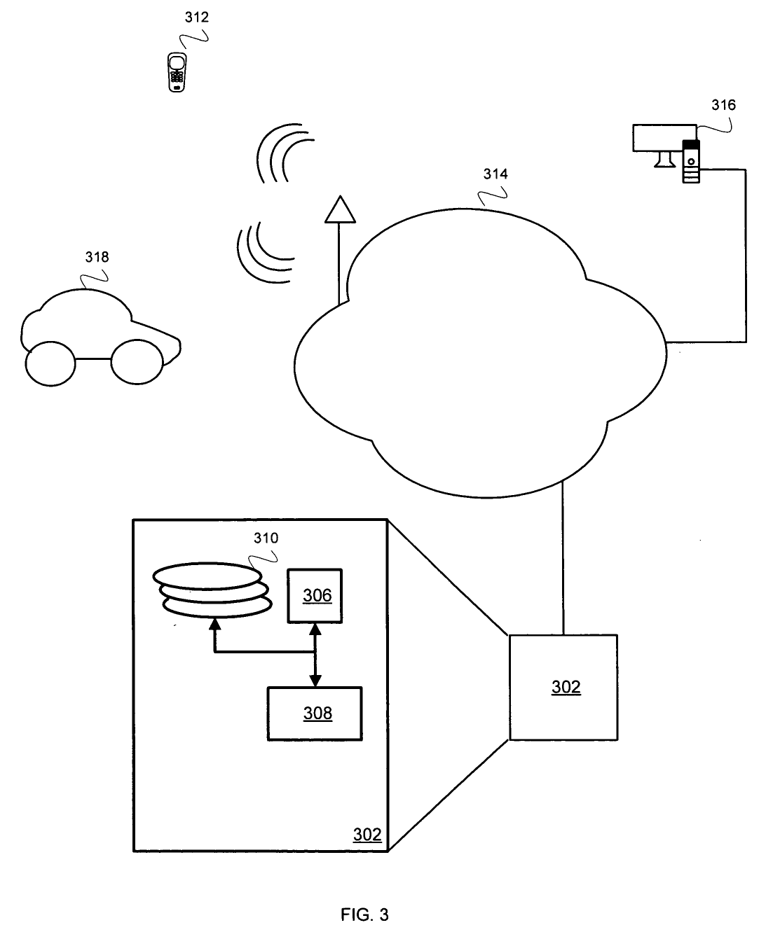

FIG. 3 is an illustration of an embodiment of a content delivery system. The content delivery system comprises one or more communication networks 314. For example, the network 314 may comprise a combination of a wired and a wireless network. Devices installed in or riding in moving vehicles such as cars 318 may receive streaming media from the content delivery system. Mobile wireless devices 312 may also receive streaming media from the content delivery system. A personal computer 316 is another example of a potential client of the content delivery system. These are merely examples of the kinds of client devices that may benefit from the improved data delivery mechanisms described herein.

The content delivery system may comprise one or more media servers 302 and associated devices and logic (switches, routers, gateways, storage systems, and so on). The media server 302 may itself comprise mass storage 310, a memory hierarchy 308, and logic 306. Of course, the media server 302 may comprise other components not as well which are not essential to the present discussion. Content files may be stored using the storage 310, and fully or partially copied to the memory 308 during streaming. Content may be streamed over the network 314 to client devices such as the mobile phone 312, a vehicle 318, or a personal computer 316.

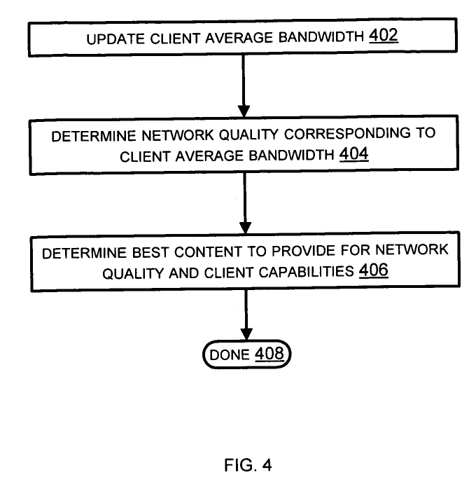

FIG. 4 is a flow chart of an embodiment of a content/codec selection process. In one embodiment, the following process is used to determine the content/codec to use at initiation or during the content streaming process:

1. The CAB 104 is updated.

2. The Network Quality (NQ 110) corresponding to the updated CAB 104 is determined.

3. The most suitable content file/codec for the NQ 110 is selected. The client must be able to support decoding of the selected content, in other words, it must have a decoder for the codec used the encode the content.

During the streaming of content, the CAB 104 and hence the NQ 110 may change. As a NQ 110 threshold for one content/codec type is crossed during a streaming event, another content/codec type may be selected. If the NQ 110 rating reaches or falls below a minimum level, the lowest quality content/codec may be chosen. Thus higher or lower quality content/codecs may be chosen dynamically during streaming to compensate for changing network conditions. The selection of content during a streaming event may involve switching to a different source file for the content, or may involve re-encoding the content on the fly with a different codec.

Content files may be encoded for multiple codec types, one or more files per codec. The content may then be streamed from the appropriate file according to network quality NQ 110 and possibly other factors, as described above. A ‘cookie’ or other mechanism may be provided to the client device to retain the streaming state at the point where the content source file is changed. The cookie may contain information indicating the file position that the next data chunk in the stream begins. In addition to the file offset, the start time and duration of the last chunk sent may also be tracked, and these values used to generate the content chunks instead of file offsets, so that in the event of a source file/codec change, the correct chunk may be located in the new source file. Thus, in some embodiments both a file offset and a duration offset may be employed to facilitate the switching of content files/codecs.

The CAB 104 and hence the NQ 110 rating is sensitive to the Number of Samples (NS 204) used in the CAB 104 calculation, hence adjusting the NS 204 allows for quicker, or slower, adaptation of content/codec type to network conditions.

In addition to proper content selection, another important consideration is selection of the packet size to use when streaming to the client. Choosing the right packet size may help reduce gaps in the content presentation by the client device.

The selection of the data packet size may be referred to herein as “adaptive chunking”. Adaptive chunking is a process whereby the media server 302 actively (i.e. during a streaming event) determines the optimum size of content “chunks” (data packets) sent to the client. One purpose of adaptive chunking for audio streaming is to provide the maximum-sized data packet at the time and under the circumstances that the data packet is requested.

The packet size determination may take into account many factors, including but not necessarily limited to the network bandwidth and the client capabilities. The data packet size is adapted primarily to reduce the presence of “gaps” in audio and video playback which may be inherent in the streaming process. Gaps may be reduced by sending larger data packets when possible to provide longer playback on the client device. The data packet size may be adapted to compensate for network quality.

Adaptive chunking may reduce the number of gaps experienced in the presentation of the content stream, by helping to compensate for network quality disruptions due to environmental changes (such as entering an elevator). Adaptive chunking attempts to provide data packets large enough to provide a time buffer for random or predictable environmental events. The changing size of the data packets may help prevent presentation gaps from appearing at known intervals. Adaptive chunking may also operate to reduce underflow by compensating for retries and previous underflows.

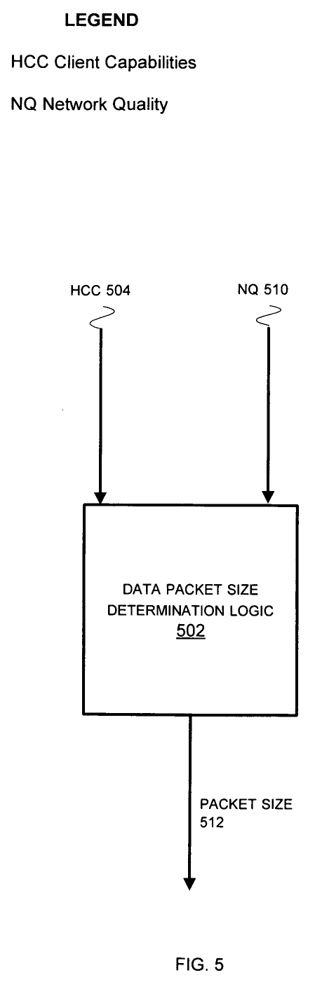

FIG. 5 is a block diagram of an embodiment of data packet size determination logic. One factor in determining the packet size is the client device capabilities HCC 504. For example, the client device may have certain hardware capabilities such as heap size, display size, processor speed, and volatile and non-volatile memory capacity. The client device may also have certain software capabilities HCC 504. For example, the client device may have installed certain codecs which it may use to decode a media stream. The client device may in some embodiments have the ability to download a codec which it may then use to decode a media stream. The client device may have a particular operating system and/or version thereof which itself has certain capabilities.

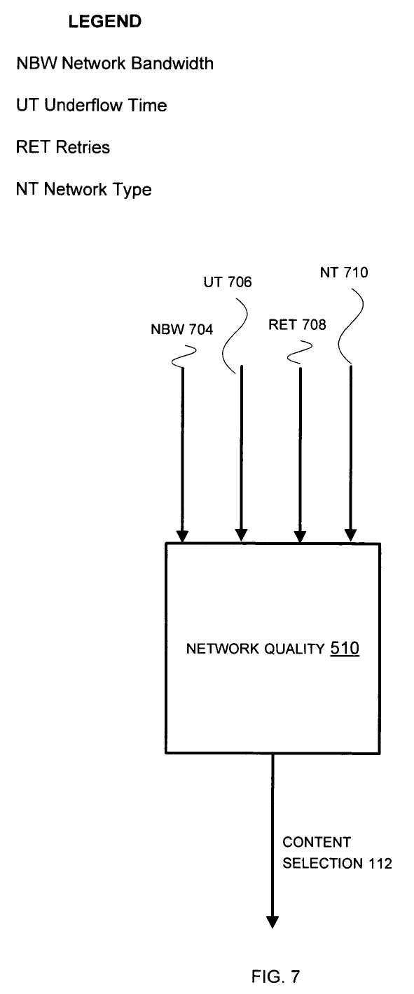

Another factor in determining the packet size to use for streaming is the Network Quality NQ 510. This may be the same Network Quality 110 metric as was used in the content selection process, or it may be determined using other factors (see FIG. 7).

The HCC 504 and NQ 510 values may be used by data packet size determination logic 502 in the content delivery system to determine the packet size 512 to use as the content is streamed. The CAB 104 value and hence the NQ 510 may vary during a streaming event, and so the packet size may be changed once, several, or many times during streaming to maximize realized bandwidth and reduce the likelihood of gaps in the content presentation by the client device.

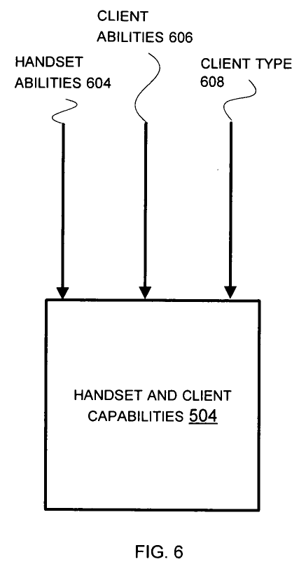

FIG. 6 is a block diagram of an embodiment of factors of handset and client capabilities. One example of client capabilities HCC 504 is the operating environment employed by the client device. For example, the Brew operating environment may require a certain predetermined size for the initial data packet of a stream, whereas if the operating environment is Java the initial packet size may vary.

Another example of client capabilities HCC 504 is the available heap (memory) size. The available memory size reported by the client may be a primary determining factor of data packet size. In some cases, knowledge of the memory footprint of client software and of current in-memory data packets may be used to approximate the amount of available memory on the client device.

Another example of client capabilities HCC 504 is which codecs and/or media qualities the client device supports. The codec set supported by the client may also determine the supported media qualities.

Yet another example of client capabilities HCC 504 is whether the client supports bookmarking of content streams. The client should support bookmarking/play progress indications when a user stops streaming a piece of content.

FIG. 7 is a block diagram of an embodiment of factors of Network Quality (NQ 510). As previously indicated, the factors in choosing NQ 510 for determining the stream packet size may vary from the factors used to determine NQ 110 for content selection. The Network Bandwidth 704, Underflow Time 706, Retries 708, and Network Type 710 may comprise factors used in determination of Network Quality 510.

Determining the Network Bandwidth 704 (NBW) may involve actively monitoring the streaming throughput to the client device to determine how fast the client device may be expected to download the data packet being preparing for it. NBW 704 may be determined by tracking the size of the last data packet received by the client and the time taken by the client to download the data packet (including time for it to prepare the data packet for playback).

Another factor in Network Quality 510 is the client Underflow Time (UT 706). Client underflow is the time from when a previous data packet was presented (e.g. finished playing) until the time a next data packet started playing. The UT 706 is useful for determining the size of the presentation gap experienced by the user of the client device.

Yet another factor in NQ 510 is the number of Retries RET 708 by the client to download a data packet. When a client retries downloading a data packet it is a significant sign of low quality network conditions. The media server 310 may detect retries in two ways: 1) the client provides an indication that a retry occurred, 2) the media server 310 may detect a request for the same data packet multiple times.

Another factor in NQ 510 is the Network Type (NT 710). Some clients may have the capability to report the type of network they are currently on. For example, a client may report a network type of “2G” or “3G’. This information may be used to determine what content types are or are not supported. The network type is not a guarantee that the bandwidth and current conditions the user is experiencing will be acceptable, but rather merely another factor that may be considered.

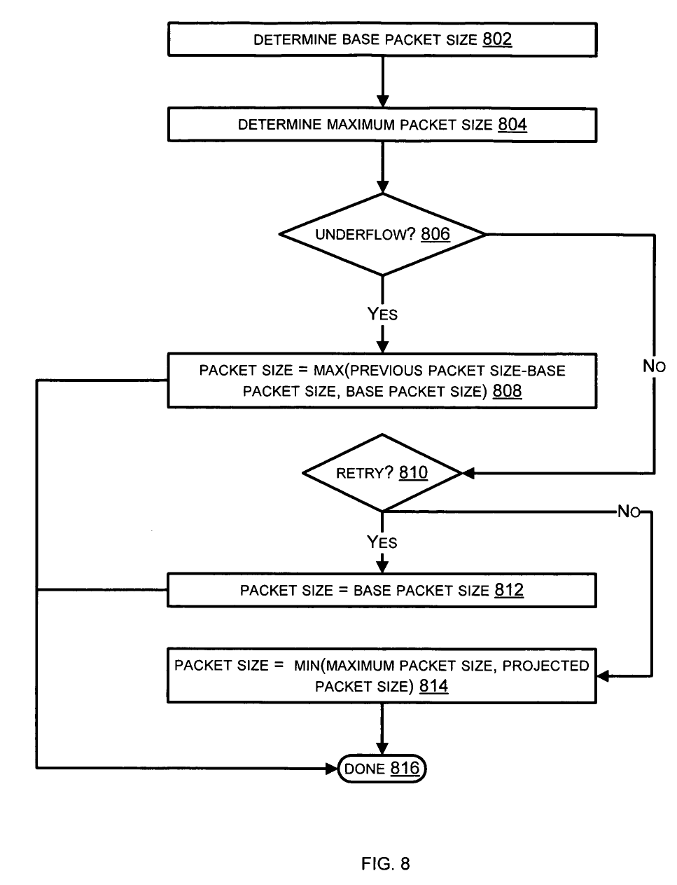

FIG. 8 is a flow chart of an embodiment of a data packet size determination process. At 802, Base Packet Size for the stream is determined. At 804, the Maximum Packet Size for the stream is determined. These two values are used, among other factors, to select the current packet size for the stream, according to whether there are underflows and retries.

If there is an underflow condition (806-808), the current packet size is set to:

Current Packet Size=MAX(Previous Packet Size−Base Packet Size, Base Packet Size).

Otherwise, if a retry is detected (810-812), the current packet size is set to:

Current Packet Size=Base Packet Size

If there is no underflow or retry (814), the current packet size is set as follows:

Current Packet Size=MIN(Maximum Packet Size, Projected Packet Size)
MAX( ) is a function that returns the largest value of those provided to it.
MIN( ) is a function that returns the smallest value of those provided to it.

One manner of determining the Base Packet Size, Maximum Packet Size, Previous Packet Size, and Projected Packet Size will now be described.

Base Packet Size

This is the starting point and the lower-limit for data packet size. Factors in determining the Base Packet Size may include:
Media Type

The “richer” the media, the fewer seconds of playback for a given size data packet. For example, 50K of 12 Kb AMR is roughly twice as much playback of a same-sized AAC+ data packet. Rich media types are assigned a larger Base Packet Size.
Client Capabilities

The Base Packet Size should not exceed the abilities of the client device. The available dent memory (e.g. heap memory) may be a factor in adjusting the Base Packet Size. A lower level may for example start at 800 Kb of client device memory heap. Devices above this 800 Kb level may receive a bump up in Base Packet Size.
Client Operating Environment

Some operating environments may place limits on the selection of the Base Packet Size. For example, Brew handsets have a fixed base data packet size due to the initial buffers available on the client being of a fixed size.

Maximum Packet Size

The Maximum Packet Size may be determined upon each client packet request based upon the client's abilities and previous data packets. This is an upper limit on the data packet size. The following factors may be considered when calculating the Maximum Packet Size:
Device Capabilities

The total available device memory (e.g. total heap size) may be reported by the device, for example at activation of the device with the media server 310. This value is useful in setting an upper bound on the packet size.
Client Device Memory Utilization

This value may be approximated from the total available memory by taking in to account the size of the previous (currently playing) packet as well as the memory requirements of software currently executing on the client device.
Extra Heap Weighting Factor

A weighting factor may be used to determine how much memory to allocate for the Maximum Packet Size below or beyond the maximum threshold. For example, a portion of that may be allocated for the maximum packet size, equal to:

heap stream allocation(HA)=(heap size−current heap allocation)*extra heap weighting factor

Projected Packet Size

The Projected Packet Size is the size of the next packet to provide in the streaming process. Calculation of this value may in some embodiments take into account the following:
Previous Packet Duration

The Previous Packet Duration may indicate the gross time window available to deliver the next packet. To avoid underflow, the next packet should be delivered to the client in the time that it will take the client to play the previous data packet.

Previous Packet Size

The Previous Packet Size and the Previous Packet Download Time may be used to calculate the bandwidth actually available to the client when the previous packet was delivered (Previous Packet Bandwidth). The Previous Packet Bandwidth may be continuously updated due to the fact that transmission rates to mobile devices may continually change as the devices move about and are subject to interference, and/or compete for bandwidth with other devices on the same network. The Previous Packet Bandwidth may provide a good approximation of the rate that can be expected to deliver the next packet to the client.
Confidence Weighting Factor

An additional weighting factor may be used to provide a safety buffer, or “level of confidence” to the Projected Packet Size. This weighting factor may account for factors inherent in the system such as connection setup time, processing time on the client (to prepare the data packet for presentation), and general network quality changes during delivery of the next packet. The weighting factor can be thought of as a “percentage of confidence” in the calculation and the network quality. This factor can be tuned for specific carrier networks if needed.
Direct Network Quality Measurements

Other network quality measurements may also be employed to determine if/how adjustments should be made in the Projected Packet Size.
Retries

If a client experiences a retry on a data packet (detected by the server or client), it is an indication that the client device is experiencing network unavailability or interruptions. When a retry event happens it may be treated as an indication to deliver the next data packet to the client as fast as possible, assuming that the previous data packet was adapted to a confidence level. When a retry event happens, a smaller data packet is delivered to the client in hopes that the smaller data packet can be delivered before the client has completed playing the data packet it is currently playing. A smaller data packet has a higher probability of being delivered as network interruptions are more likely to cause a failure of larger data packets which take longer to deliver.
Underflow

An underflow indicates that the client device did not receive the previous packet before the packet delivered before that was finished playing. Underflow may be an indication that larger packets will be unlikely to arrive at the client device in due time. In this scenario a next packet smaller than the previous one may be sent in hopes that it will arrive before the currently-playing packet has completed.

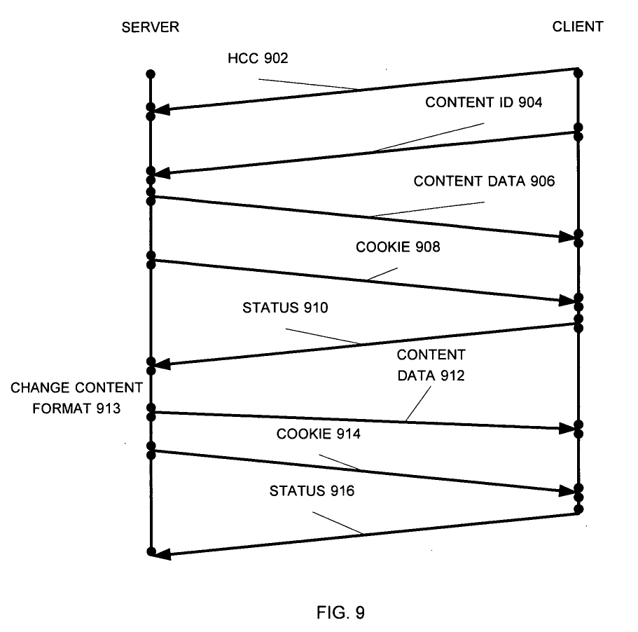

FIG. 9 is a sequence diagram of one embodiment of client-server interaction for dynamic content selection. At 902 the client device communicates handset and client capabilities (e.g. HCC 504) to the media server. The HCC information may include, for example, the client device's heap capacity, heap utilization, and its hardware and/or software capabilities (supported codecs, screen resolution, processor speed, etc.), among some of the possibilities. At 904 the client may request that certain content be streamed from the server. In some embodiments, a client stream request to the media server (for example, a first request) may cause the server to request the HCC information from the client. In other words, act 904 may in some cases result in act 902.

At 906 the server begins streaming content data to the client. Content may be streamed in chunks. Along with a data chunk, or prior to or after providing the chunk, the server may communicate a ‘cookie’ or other indication of streaming state to the client (act 908). The client may save this information which may prove useful if circumstances indicate that the content format should change. The state information (‘cookie’) may include such information as the current offset into the stream file for the last data chunk, the duration (in presentation terms) of the last data chunk, the size of the last data chunk, and its content format type. The client may respond to the chunk, or after a number of chunks, or periodically, with status information (act 910). For example, the status may include information such as the id of the content to which it applies (e.g. a stream or program id), the number of accumulated retries or retries over a period of time, or retries for a particular chunk (for example), and the time that it took the client to download the last chunk (or multiple chunks, depending on the implementation). The status may, in some situations, also identify a ‘cookie’ for a chunk with which it should be identified.

The server continues to stream content to the client (act 912) until circumstances, such as network quality, indicate that the content format should change. For example, improving network quality may lead the server to switch to a higher quality content format (for the same content, e.g. the same program, video, audio file, etc). Or degenerating network quality may lead the server to switch to a lower quality content format (e.g. switching to mono audio from stereo audio). The server changes the content format (act 913), possibly utilizing the status information communicated from the client. A new cookie is provided (act 914) reflecting the chunk of the new format stream that is substituted for the previous one, but which the client may receive as part of the same streaming session (no need to start a new stream). The client receives and renders the new chunk, saves the new cookie, and provides status (act 916), and streaming continues as before.

While the preferred embodiment of the invention has been illustrated and described, as noted above, many changes can be made without departing from the spirit and scope of the invention. For example, in the sequence diagram, cookies may not be delivered to the client devices. Accordingly, the scope of the invention is not limited by the disclosure of the preferred embodiment. Instead, the invention should be determined entirely by reference to the claims that follow.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A media server to stream content a client device over one or more network connections of varying quality comprising:
logic to continually determine a network quality level during streaming of content; and
logic to change a codec used to encode the content, the codec selected at least in part according to the network quality level.

2. The media server of claim 1, wherein the logic to change a codec used to encode the content further comprises:
logic to change a content file from which a content stream is derived.

3. The media server of claim 1, wherein the logic to change a codec used to encode the content further comprises:
logic to select a codec to re-encode the stream from a stored encoding of the stream.

4. The media server of claim 1, wherein the logic to continually determine a network quality level during streaming of content further comprises:
logic to determine a client average bandwidth from a moving window of bandwidth samples.

5. The media server of claim 1, wherein the logic to change a codec used to encode the content further comprises:
logic to select a new codec to encode the content, taking into account client device capabilities to support the new codec.

6. The media server of claim 1, further comprising:
logic to dynamically change a data packet size for a content stream.

7. The media server of claim 6, wherein the logic to dynamically change a data packet size for a content stream further comprises:
logic to determine a maximum packet size compatible with client memory conditions.

8. The media server of claim 6, wherein the logic to dynamically change a data packet size for a content stream further comprises:
logic to determine a maximum packet size that takes into account at least one of recent underflow and retry events.

9. A process to stream content to a client device over one or more network connections of varying quality, comprising:
continually determining a network quality level during streaming of content; and
changing a codec used to encode the content, the codec selected at least in part according to the network quality level.

10. The process of claim 9, wherein changing a codec used to encode the content further comprises:
changing a content file from which a content stream is derived.

11. The process of claim 9, wherein changing a codec used to encode the content further comprises:
selecting a codec to re-encode the stream from a stored encoding of the stream.

12. The process of claim 9, wherein continually determining a network quality level during streaming of content further comprises:
determining a client average bandwidth from a moving window of bandwidth samples.

13. The process of claim 9, wherein changing a codec used to encode the content further comprises:
selecting a new codec to encode the content, taking into account client device capabilities to support the new codec.

14. The process of claim 9, further comprising:
dynamically changing a data packet size for a content stream.

15. The process of claim 14, wherein dynamically changing a data packet size for a content stream further comprises:
determining a maximum packet size compatible with client memory conditions.

16. The process of claim 14, wherein dynamically changing a data packet size for a content stream further comprises:
determining a maximum packet size that takes into account at least one of recent underflow and retry events.
